(19) United States
(12) Patent Application Publication
(10) Pub. No.: US 2005/0173677 A1
(43) Pub. Date: Aug. 11, 2005

(54) Mutual solvent for improved oil and gas permeability

(75) Inventors: Shaun T. Mesher, Calgary (CA); David L. Edwards, Calgary (CA)

Correspondence Address: THOMPSON LAMBERT;SUITE 703D, CRYSTAL PARK TWO, 2121 CRYSTAL DRIVE, ARLINGTON, VA, 22202, US

(73) Assignee: SynOil Fluids Inc.

(21) Appl. No.: 10/773,176

(22) Filed: Feb. 9, 2004

(51) Int. Cl. B01F 1/00

(52) U.S. Cl. 252/364

(57) ABSTRACT

A solvent system for use in acidizing and cleanup in oil wells and gas wells. The solvent system comprises a substantially water-soluble alcohol, such as methanol, or ethanol or any mixture thereof, a substantially water/oil-soluble ester, such as one or more C.sub.2-esters through C.sub.10-esters and a substantially water/oil-soluble ketone, such as one or more C.sub.2-ketones through C.sub.10-ketones.

### BACKGROUND OF THE INVENTION

Paraffinic and asphaltenic hydrocarbons, as well as calcium carbonate and clays, may form undesirable deposits in boreholes and equipment used for the production of oil and gas from underground formations. The problem of removing such deposits is discussed in U.S. Pat. Nos. 5,152,907 and 6,242,388, and typically involves using an aqueous solution of an acid, such as hydrochloric acid, hydrofluoric acid, acetic acid, and the like, and mixtures thereof, in combination with a mutual solvent of oil and water. A challenge in the art of acidizing wells is to provide a solvent system with a mutual solvent that is effective in cleaning wells and production equipment, while being economical and environmentally friendly.

### SUMMARY OF THE INVENTION

There is therefore provided a solvent system for use in acidizing and cleanup in oil wells and gas wells. The solvent system comprises a combination thereof, a substantially water-soluble alcohol, such as methanol, or ethanol or any mixture thereof, a substantially water/oil-soluble ester, such as one or more C₂-C₁₀ esters and a substantially water/oil-soluble ketone, such as one or more C₂-C₁₀ ketones. A preferred ketone solvent is methyl ethyl ketone. A preferred substantially water-soluble alcohol is methanol. A preferred substantially water/oil-soluble ester is methyl acetate.

The ketone solvent may be present in an amount from 10 wt % to about 50 wt %; the substantially water soluble alcohol, in an amount within the range of about 5 wt % to about 50 wt %; and the substantially water/ oil-soluble ester in an amount within the range of about 5 wt % to about 50 wt %, each amount being based upon the weight of the solvent system.

The preferred ketone solvent may be present in an amount from 40 wt % to about 50 wt %; the substantially water-soluble alcohol, in an amount within the range of about 20 wt % to about 30 wt %; and the substantially water/oil-soluble ester, in an amount within the range of about 20 wt % to about 30 wt %, each amount being based upon the weight of the solvent system.

Further summary of the invention is found in the claims, which are incorporated by reference here.

### DETAILED DESCRIPTION OF PREFERRED EMBODIMENTS OF THE INVENTION

The term “comprising” is used in its inclusive sense, and does not exclude other components being present. The terms “water soluble” and “oil soluble” mean substantially water and oil soluble respectively. All percentages used herein are weight percent of the total weight of the ester, alcohol and ketone/cyclic ether components of the solvent system, in the cases where no acid is present, and weight percent of the total weight of the acid, ester, alcohol and ketone/cyclic ether components of the solvent system, in the cases where acid is present.

The preferred components for this solvent system for use in oil and gas well operations are a water/oil soluble ester, a water-soluble alcohol, and a water/oil-soluble solvent, either or both of a ketone or cyclic ether. The water/oil soluble ester may be methyl acetate, present in the amount of about 5 wt % to 50 wt %, for example 25 wt %, and the water-soluble alcohol may be methanol, present in the amount of about 5 wt % to 50 wt %, for example about 25 wt %. If a water/oil soluble ketone is used, it may be methyl ethyl ketone (acetone) present in the amount of about 10 to 50 wt %. The water/oil soluble ester may be methyl acetate present in the amount of about 25 wt %.

Instead of methyl ethyl ketone, a water/oil soluble cyclic ether may be used, for example from about 5 wt % to about 50 wt % tetrahydrofuran. A combined amount of the cyclic ether and ketone may be present in the amount of from about 5 wt % to about 50 wt %.

The water/oil-soluble ketone may be a mixture of C₃-C₁₀ ketones. The water/oil-soluble ester may be a mixture of C₂-C₁₀ esters. The water/oil soluble cyclic ether may be a mixture of C₂-C₁₀ ethers.

An aqueous acid may be added to the solvent system. For example the acid may be present in the amount of 5 wt % to 50 wt %. With 50 wt % hydrochloric acid 15%, the water/oil soluble ester may be about ethyl acetate present in the amount of 12.5 wt %, the water-soluble alcohol may be methanol present in the amount of about 12.5 wt %, and the water/oil soluble-ketone may be about methyl ethyl ketone present in the amount of about 25 wt %.

In another example, the solvent system may comprise about 12.5 wt % methyl acetate, about 12.5 wt % methanol, about 25 wt % methyl ethyl ketone and about 50% wt % hydrochloric acid 15%. The ketone may be replaced by an equal weight of tetrahydr-ofril-all. Other water soluble inorganic and organic acids may be used for the aqueous acid.

Example: A scale example was prepared by adding 10 g of heavy oil (density=985 kg/m3) to calcium carbonate (15 g). The scale sample was mixed thoroughly and allowed to age overnight. The scale sample was then weighed out in 2 to 4 g sizes and added to a 100 ml solution (listed below) and the reactions were observed.

| | | Ketone/ | | |
|---|---|---|---|---|
| Alcohol | Ester | Ether | Acid | Observations |
| | | | 15% HCl | No oil separation, |
| | | | (100%) | no effervescence |
| Methanol | | THF (25%) | 15% HCl | Complete oil separa- |
| (25%) | | | (50%) | tion/effervescence in |
| | | | | 20 mins |
| Methanol | | THF (12.5%)/ | 15% HCl | Incomplete oil sepa- |
| (25%) | | Acetone | (50%) | ration after 30 mins |
| | | (12.5%) | | |
| Methanol | | THF (18.75%)/ | 15% HCl | Complete oil separa- |
| (12.5%) | | Acetone | (50%) | tion/effervescence in |
| | | (18.75%) | | 25 mins |
| | | THF (10%)/ | 15% HCl | Complete oil separa- |
| | | Acetone | (50%) | tion/effervescence in |
| | | (40%) | | 10 mins |
| | | THF (7.5%)/ | 15% HCl | Complete oil separa- |
| | | Acetone | (50%) | tion/effervescence in |
| | | (42.5%) | | 15 mins |
| | | THF (5%)/ | 15% HCl | Complete oil separa- |
| | | Acetone | (50%) | tion/effervescence in |
| | | (45%) | | 20 mins |
| Methanol | Methyl | | 15% HCl | Complete oil separa- |
| (16.5%) | acetate | | (50%) | tion/effervescence in |
| | (33.5%) | | | 15 mins |
| Methanol | Methyl | THF (12.5%)/ | 15% HCl | Complete oil separa- |
| (8.25%) | acetate | Acetone | (50%) | tion/effervescence in |
| | (16.75%) | (12.5%) | | 11 mins |
| Methanol | Methyl | MEK (10%) | 15% HCl | Complete oil separa- |
| (13.6%) | acetate | | (50%) | tion/effervescence in |
| | (26.4%) | | | 7 mins |
| Methanol | Methyl | MEK (25%) | 15% HCl | Complete oil separa- |
| (8.25%) | acetate | | (50%) | tion/effervescence in |
| | (16.75%) | | | 5 mins |
| Methanol | Methyl | THF (0.8%) | 15% HCl | Incomplete oil sepa- |
| (10.4%) | acetate | | (50%) | ration after 30 mins |
| | (38.8%) | | | |
| Methanol | Methyl | THF (0.6%)/ | 15% HCl | Complete oil separa- |
| (7.8%) | acetate | MEK (12.5%) | (50%) | tion/effervescence in |
| | (29.1%) | | | 15 mins |
| Methanol | Methyl | THF (0.2%)/ | 15% HCl | Complete oil separa- |
| (5.2%) | acetate | MEK (25%) | (50%) | tion/effervescence in |
| | (19.4%) | | | 5 mins |
| Methanol | Methyl | THF (0.5%)/ | 15% HCl | Complete oil separa- |
| (17%) | acetate | MEK(12.5%) | (50%) | tion/effervescence in |
| | (20%) | | | 15 mins |
| Methanol | Methyl | THF (0.5%)/ | 15% HCl | Complete oil separa- |
| (10.5%) | acetate | MEK (25%) | (50%) | tion/effervescence in |
| | (14%) | | | 4 mins |

Immaterial modifications may be made to the invention described here, without departing from the invention as defined by the claims.

1. A solvent system for use in oil and gas operations, the solvent system comprising:
an alcohol that is water soluble;
an ester that is water and oil soluble;
and a solvent that is at least one of a ketone that is water and oil soluble and a cyclic ether that is water and oil soluble.

2. The solvent system of claim 1 in which the solvent is a ketone.

3. The solvent system of claim 1 in which the solvent comprises a C₃-C₁₀ ketone.

4. The solvent system of claim 3 in which the solvent comprises methyl ethyl ketone.

5. The solvent system of claim 3 in which the alcohol is present in the amount of at least 5% by weight of the solvent system, the ester is present in the amount of at least 5% by weight of the solvent system and the methyl ethyl ketone is present in the amount of between 10% and 50% by weight of the solvent system.

6. The solvent system of claim 1 in which the alcohol is present in the amount of at least 5% by weight of the solvent system, the ester is present in the amount of at least 5% by weight of the solvent system and a ketone is present in the amount of between 10% and 50% by weight of the solvent system.

7. The solvent system of claim 6 further comprising an aqueous acid.

8. The solvent system of claim 7 in which the aqueous acid is present in the amount of between 10% and 50% by weight of the solvent system.

9. The solvent system of claim 10 in which the acid is hydrochloric acid.

10. The solvent system of claim 6 in which the ester is a C₂-C₁₀ ester.

11. The solvent system of claim I in which the solvent is a cyclic ether.

12. The solvent system of claim 11 in which the solvent comprises a C₃-C₁₀ cyclic ether.

13. The solvent system of claim 12 in which the solvent comprises tetrahydrofuran.

14. The solvent system of claim 13 in which the alcohol is present in the amount of at least 5% by weight of the solvent system, the ester is present in the amount of at least 5% by weight of the solvent system and the tetrahydrofuran is present in the amount of between 10% and 50% by weight of the solvent system.

15. The solvent system of claim 14 further comprising an aqueous acid.

16. The solvent system of claim 15 in which the aqueous acid is present in the amount of between 10% and 50% by weight of the solvent system.

17. The solvent system of claim 16 in which the acid is hydrochloric acid.

18. The solvent system of claim 1 in which the alcohol is present in the amount of at least 5% by weight of the solvent system, the ester is present in the amount of at least 5% by weight of the solvent system and the solvent is present in the amount of between 10% and 50% by weight of the solvent system.

19. The solvent system of claim 18 in which the solvent comprises methyl ethyl ketone and tetrahydrofuran.

20. The solvent system of claim 18 further comprising an aqueous acid.

21. The solvent system of claim 20 in which the aqueous acid is present in the amount of between 10% and 50% by weight of the solvent system.

22. The solvent system of claim 21 in which the acid is hydrochloric acid.
